(19) United States
(12) Patent Application Publication
(10) Pub. No.: US 2005/0145683 A1
(43) Pub. Date: Jul. 7, 2005

(54) Tamper evident package

(76) Inventors: Steven M. Alagna, Olympia, WA (US); Brad C. Irwin, Shingle Springs, CA (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/748,727

(22) Filed: Dec. 29, 2003

(51) Int. Cl. B65D 17/00; B26D 5/42

(52) U.S. Cl. 229/102; 229/198.2; 229/222; 229/241

(57) ABSTRACT

Tamper evident packages and methods pertaining to tamper evident packages are provided. The tamper evident packages may include two corresponding flaps with at least one of two corresponding flaps having a number of perforations formed therein to facilitate seepage of an adhesive employed to join the flaps into fibrous material of the flap, such that when the two are separated, the package is at least partially destroyed, thus making tampering evident.

### FIELD OF THE INVENTION

Disclosed embodiments of the invention relate to the field of packaging. More specifically, disclosed embodiments of the invention relate to tamper evident packaging that may help prevent counterfeiting.

### BACKGROUND

Currently, a high percentage of semiconductor devices and related products that are sold to end users, distributors, or other buyers in retail type packaging are being tampered with. Such tampering may include, but is not limited to non-destructibly opening the package and replacing the contents, such as a digital camera, a DVD player, a gaming device, a microprocessor, software, or a fan and heatsink, with a counterfeit product. The original package is then resealed and sold as if it were an original product. Such counterfeiting and reuse of retail packaging is a growing concern.

### BRIEF DESCRIPTION OF THE DRAWINGS

The invention is illustrated by way of example and not by way of limitation in the figures of the accompanying drawings, in which the like references indicate similar elements and in which:

FIG. 1 illustrates a plan view of a tamper evident package in accordance with an embodiment of the present invention;

FIG. 2 illustrates an enlarged view of a portion of the tamper evident package of FIG. 1 in accordance with an embodiment of the present invention;

FIG. 3 illustrates a perspective view of a tamper evident package in accordance with an embodiment of the present invention;

FIG. 4 illustrates a perspective view of a tamper evident package in accordance with an embodiment of the present invention; and

FIG. 5 illustrates a perspective view of a tamper evident package in accordance with an embodiment of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

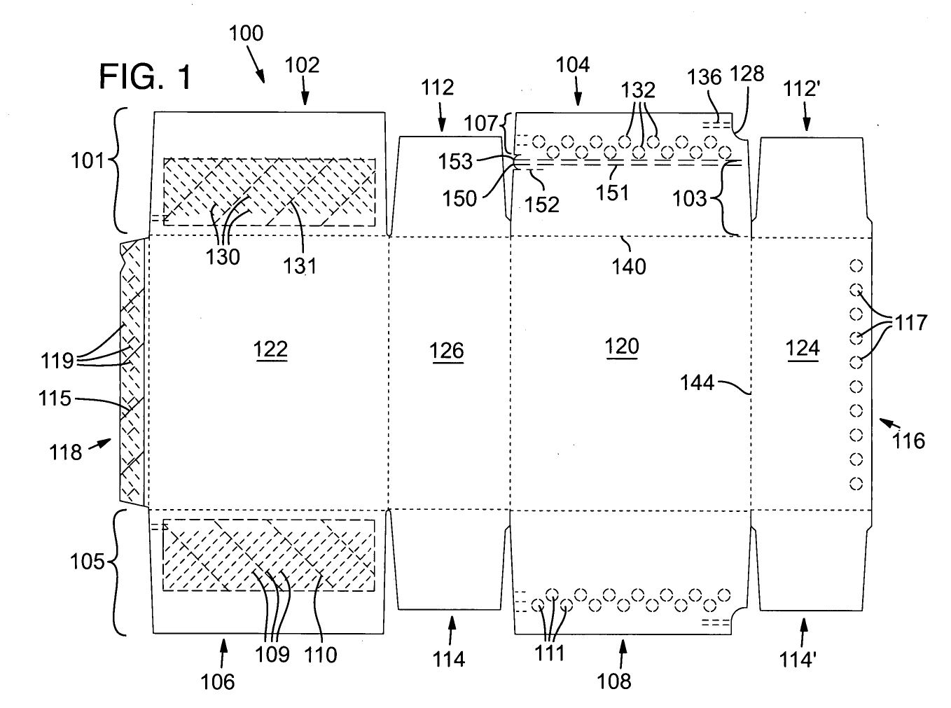

FIG. 1 illustrates a plan view of a tamper evident package in accordance with an embodiment of the present invention. A package 100 as shown is in its pre-formed configuration such that it lies substantially flat. Package 100 has several features which when used in combination with an adhesive, may resist the ability of the package 100 to be opened without at least partially destroying a portion of the package. Such package destruction would help reveal whether the contents may have been tampered with.

In one embodiment in accordance with the present invention, package 100 generally has a number of ends/sides. For ease of understanding, they shall be referred to as first end 101, second end 105, top 120, bottom 122, first side 124, and second side 126. First end 101 may consist of two inside minor flaps, 112, 112′, an inside major flap 102, and an outside major flap 104. Inside minor flaps 112, 112′ fold inward on fold line 140. Inside major flap 102 then may fold inward on fold line 140, overlaying a portion of the inside minor flaps 112, 112′. Outside major flap 104 also may fold along fold line 140 and may overlay at least a portion of the inside major flap 102. Second end 105 may have a similar flap and folding configuration, including inside minor flaps 114, 114′, inside major flap 106, and outside major flap 108.

Hot glues may be used to secure portions of a package together. Conventional packages without features of the present invention may be easily opened without destruction of the packaging, thus enabling reuse. For example, a hot glue joint of a conventional package may be separated using a heat treatment, such as for example by a heat gun or by using a sharp blade. Part of the reason hot glue joints are so easily tampered with is because the hot glue does not penetrate the fibrous material of the flap. Additionally, it may be due to the glue's composition or the gloss coating found usually on paper based packaging.

Embodiments in accordance with the present invention use penetrating adhesives to secure the package, enabling saturation of the adhesive into the fibrous material such that separating flaps of the package may result in a tearing of portions of the fibrous material. Also, in various embodiments, perforations may be used to enhance penetration of an adhesive and further enable destruction of the package when the flaps are separated from each other.

In one embodiment in accordance with the present invention, inside major flap 102 of first end 101 may have a plurality of perforations 130 disposed on a portion of its surface. The perforations 130 may penetrate into the fibrous material of inside major flap 102, which in turn may enable an adhesive 131 to seep into the perforations and penetrate the fibrous material of the package, and, upon curing, create destructible penetration and a resulting destructible bond. Thus, when outside major flap 104 is separated from inside major flap 102, tear residual, such as portions of the fibrous material of one flap, may stay adhered to the other flap.

The perforations 130 may extend in a diagonal direction across a portion of the width of the inside major flap 102. It can be appreciated however that the perforations may be arranged in a vertical or horizontal relationship, or randomly disposed. The perforations may also be concentrated toward the inner end of the flap closer to where the inside major flap bends along fold line 140. Such placement of perforations 130 may enable adhesion between the outer portion 107 of the outside major flap 104 to the inside major flap 102, without destructible penetration between the inside portion 103 of outside major flap 104 and the inside major flap 102.

In another embodiment in accordance with the present invention, outside major flap 104 may have a plurality of perforated shapes 132, which are geometric shapes defined by a perforation pattern, which may traverse across the width of the underside of the outer portion 107. As illustrated, the perforated shapes 132 are circular. It can be appreciated, however, that the shape can be of any geometry.

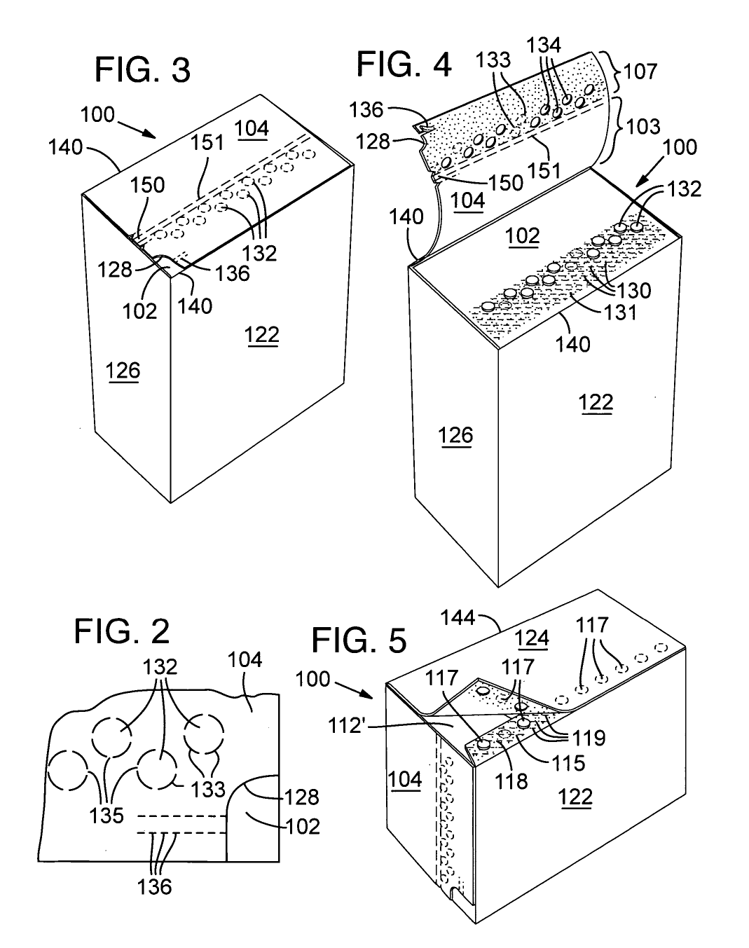

FIG. 2 illustrates an enlarged view of a portion of the outside major flap 104 in accordance with an embodiment of the present invention. Perforated shapes 132 may be formed by a plurality of die-cut perforations 133 separated by non-perforated portions 135. To maintain the exterior appearance of outside major flap 104 without revealing the presence of the perforated shapes 132, the perforations 133 may penetrate into the fibrous material but not pass completely through to the topside of the outside major flap 104.

Referring back to FIG. 1, an adhesive 131 may be applied to the perforations 130. When package 100 is folded into its assembled form (see, e.g., FIG. 3), outside major flap 104 overlays inside major flap 102. The outer portion 107 may overlay the perforations 130 of the inside major flap 102. The adhesive 131 can penetrate both the perforations 130 on inside major flap 102 as well as the perforations 133 of perforated shapes 132, creating a destructible bond therebetween.

FIG. 3 illustrates a perspective view of a tamper evident package in accordance with an embodiment of the present invention, where package 100 is in an assembled and sealed configuration. FIG. 4 illustrates a perspective view of a tamper evident package in accordance with an embodiment of the present invention. FIG. 4 shows a package 100 that has been tampered with, where there is a tear residual of at least some of the perforated shapes 132 adhered to the other flap. The illustrated results are due in at least in part adhesive 131 having penetrated into the fibrous material via the perforations 130 and 133. When the adhesive cures and the outside major flap 104 is separated from the inside major flap 102, a number of tamper evident results can occur. For example, the perforated shapes 132 may remain adhered to the inside major flap 102 as tear residual, thereby leaving a void 134 in outside major flap 104. This will indicate that the package 100 has been possibly tampered with. Another result, though not shown, may be that due to the adhesive penetration of the inside major flap 102 and the outside major flap 104 fibrous material, portions of the outside major flap 104 or inside major flap 102 may be separated or ripped, and remain adhered to the other flap as tear residual.

In another embodiment in accordance with the present invention, which may work in conjunction with the perforations 130 and perforated shapes 132 is the use of a tear strip 150. Tear strip 150 may consist of a strip of material 151 that may be secured to the backside of the outside major flap 104 and extend substantially across the width of the outside major flap 104. Tear strip 150 can be used to easily open the package 100 by pulling on the tear strip 150. In various embodiments, material 151 is of sufficient strength, that tear strip 150 can tear through the outside major flap 104 without breaking.

The tear strip 150 may also be positioned towards the middle of the outside major flap 104, at a position such that tear strip 150 does not overlay any adhesive 131 or perforations on inside minor flap 102. This may enable the inner portion 103 of inside major flap 104 to be easily opened once the tear strip 150 is removed, as no destructible bond exists between the inner portion 103 and the inside major flap 102. Removal of the tear strip 150 will sufficiently damage the packaging and reveal that it has in fact been previously opened, if not removed by the end user. Also, to facilitate removal of tear strip 150, a tabbed indentation 153 (shown in FIG. 1) may be positioned on the edge of the outside major flap 104 for easy gripping. Perforations 152 may extend from the tabbed indentation 153 into a portion of the outside major flap 104, which can help initiate removal of the tear strip 150.

As shown in FIGS. 1-4, another embodiment of a tamper evident feature in accordance with the present invention includes a pair of perforations 136 near the outer end of outside major flap 104. As shown, the perforations 136 extend from a thumb notch 128 inward a certain distance. Thus as shown in FIG. 4, when an attempt to separate the outside major flap 104 from the inside major flap 102, the adhesive bond may overcome the nonperforated portion 136 such that the perforations will tear inward and reveal tampering.

Many of the tamper evident features of the various described embodiments in accordance with the present invention may be utilized with respect to the second end 105 of package 100. For example, and as shown in FIG. 1, inside major flap 106 may have a plurality of perforations 109 in which an adhesive 110 may penetrate the fibrous material. As shown in FIG. 1, outside major flap 108 may have perforated shapes 111, which when adhered to the perforations 109 of inside major flap 106, may result in tamper evident perforated shapes 111 remaining adhered to inside flap 106 and corresponding voids in outside major flap 108. Other tamper evident features may be used on second end 105, but may not be necessary.

When a package is manufactured, typically one side is secured by the package manufacturer, so that only the first end 101 and second end 105 need to be sealed after the material being packaged is inserted. This is often referred to as the manufacturer's joint. As illustrated in FIG. 1, the manufacturer's joint may be formed by folding side outside flap 116 along side fold line 144 such that it overlays side inside flap 118. The manufacturer's joint may use tamper evident features previously described in embodiments in accordance with the present invention, and as illustrated in FIG. 5. For example, die-cut shapes 117 may traverse a portion of the side outside flap 116 and overlay perforations 119 in side inside flap 118. Adhesive 115 may penetrate the fibrous material of both the perforations 119 and the perforated portions of the die-cut shapes 117, thereby securing the side outside flap 116 to the side inside flap 118 in a tamper evident fashion.

With respect to the embodiments in accordance with the present invention where the adhesive penetrates the fibrous material of the flaps, a variety of adhesives may be used, including, but not limited to, water-based adhesives and/or non-water-based adhesives. These adhesives may also be referred to as cold glues, indicating that they are glues that are applied under normal conditions and have a longer curing time. An example of a water-based adhesive is Resyn 33-9192 manufactured by National Adhesives. The water-based adhesives generally penetrate the fibrous material better than the non-water-based adhesives. However, water-based adhesives tend to have a longer curing period and may not be able to hold the outside major flap 104 to the inside major flap 102 without application of external force for a longer period of time.

Accordingly, in one embodiment in accordance with the present invention, hot glue may be used to temporarily secure the flaps together while the adhesive or cold glue cures, as hot glues typically have a quick cure time and have stronger uncured forces of attraction. An example of a hot glue that is sufficient to hold the flaps together while the cold glue cures is Cool Lok 340-250A, also manufactured by National Adhesives.

Since hot glue sealed joints have proven to be easily tampered with, the water-based adhesive may provide the adhesion between the flaps such that any attempt to unseal the outside major flap from the inside major flap or break the manufacturer's joint will be readily observable in the partial destruction of the package.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

1. A tamper evident package, comprising:
a first flap comprised of a fibrous material; and
a second flap comprised of a fibrous material, and having a surface with a plurality of perforations disposed on at least a portion of the surface, to facilitate adhesive, employed to join the second flap to the first flap, to seep into the fibrous material.

2. The tamper evident package of claim 1, wherein the second flap is a selected one of an inside major flap and a side inside flap.

3. The tamper evident package of claim 2, wherein the surface of the second flap has an inner portion and an outer portion, and the perforations being concentrated at the inner portion.

4. The tamper evident package of claim 3, wherein the perforations are linearly or randomly disposed.

5. The tamper evident package of claim 3, wherein the perforations are disposed to define at least one geometric shape.

6. The tamper evident package of claim 1, wherein the second flap is a selected one of an outside major flap and a side outside flap.

7. The tamper evident package of claim 6, wherein the surface of the second flap has an inner portion and an outer portion, and the perforations being concentrated at the outer portion.

8. The tamper evident package of claim 7, wherein the perforations are linearly or randomly disposed.

9. The tamper evident package of claim 8, wherein the perforations are disposed to define at least one geometric shape.

10. The tamper evident package of claim 1, wherein the first flap has a surface with a plurality of perforations disposed on at least a portion of the surface, to facilitate the adhesive to seep also into its fibrous material.

11. The tamper evident package of claim 10, wherein the perforations of the first flap are disposed in an outer portion of an under surface of the first flap, and the perforations of the second flap are disposed in an inner portion of an outer surface of the second flap, such that the perforations in the first flap overlay the perforations in the second flap.

12. The tamper evident package of claim 11, wherein the perforations of the first flap are disposed to define at least one geometric shape and the perforations of the second flap are linearly or randomly disposed.

13. The tamper evident package of claim 1, wherein a selected one of the first and the second flap further includes a tear strip configured to destructibly open the package after the package has been assembled.

14. The tamper evident package of claim 1, wherein a selected one of the first and the second flap comprises:
a thumb notch; and
a pair of perforations extending from the thumb notch across a portion of the selected one of the first and the second flap.

15. The tamper evident package of claim 1, wherein the first flap and the second flap are a selected one of (a) an inside major flap and an outside major flap, (b) an outside major flap and an inside major flap, (c) a side inside flap and a side outside flap, and (d) a side outside flap and a side inside flap.

16. The tamper evident package of claim 13, the first and second flaps are side outside and inside flaps, and form a manufacturer's joint.

17. A method, comprising:
applying adhesive to at least a portion of a surface of a first flap of a tamper evident package, where the portion to which adhesive is applied has a plurality of perforations that allow portions of the adhesive to seep into fibrous material of the first flap;
joining the first flap with a second flap of the tamper evident package to contribute in assembling the tamper evident package; and
curing the adhesive to form a tamper evident seal between the first flap and the second flap.

18. The method of claim 17, wherein joining the first flap with a second flap includes providing a plurality of perforated shapes in the second flap concentrated toward an outer portion of the second flap.

19. The method of claim 17, wherein curing the adhesive comprises disposing a portion of hot glue between the first flap and the second flap to secure the inside major flap to the outside major flap while the adhesive cures.

20. The method of claim 17, wherein providing the tamper evident package further comprises providing a tear strip in first flap or the second flap to allow destructible opening of the tamper evident package.

21. The method of claim 17, further comprising:
placing a selected one of a microprocessor, a digital camera, a gaming device, a DVD player, fan, heatsink, and software into the tamper evident package.
